(19) United States
(12) Patent Application Publication
(10) Pub. No.: US 2003/0164456 A1
(43) Pub. Date: Sep. 4, 2003

(54) Apparatus and method for detecting fecal and ingesta contamination on hands using an lllumination imaging device

(75) Inventors: Jacob W. Petrich, Ames, IA (US); Thomas A. Casey, Ames, IA (US); Mark A. Rasmussen, McCallsburg, IA (US); Albin H. Gapsch, Melbourne, FL (US); Ricky Lee Flick, Merritt Island, FL (US); Richard D. Stroman, Indialantic, FL (US); Roberta A. Tippens, Weatherford, OK (US)

Correspondence Address: FOWLER WHITE BOGGS BANKER, P.A., 501 E. KENNEDY BOULEVARD, SUITE 1700, TAMPA, FL, 33602, US

(73) Assignee: eMerge Interactive, Inc.

(21) Appl. No.: 10/372,185

(22) Filed: Feb. 21, 2003

Related U.S. Application Data
(60) Provisional application No. 60/359,507, filed on Feb. 25, 2002.
(60) Provisional application No. 60/359,509, filed on Feb. 25, 2002.

(51) Int. Cl. G01N 21/64

(52) U.S. Cl. 250/458.1

(57) ABSTRACT

According to the present invention, there is disclosed a system and a method for detecting the presence of fecal contamination or ingesta on objects, such as a protein source, a worker's hands or utensils. In one embodiment, there is included a supporting structure which supports a diffuse light source, the light source emitting light having a wavelength effective to elicit fluorescence from the ingesta or fecal matter at a wavelength between about 660 to 680 nm into an area adjacent to the system, and a light detection device to detect light at a wavelength between about 660 to 680 nm from the area adjacent to the system. The detection of light at a wavelength between about 660 to 680 nm indicates the presence of fecal contamination or other ingesta. There is also disclosed a method of using such a device to detect the presence of such contamination, optionally including further steps to identify the source of any contamination and to modify any practices so that the spread of contamination may be reduced.

### CROSS-REFERENCE TO RELATED APPLICATION

The present application claims the benefit of two previously filed co-pending Provisional Patent Applications, Ser. Nos. 60/359,507 and 60/359,509, both filed Feb. 25, 2002.

### GOVERNMENT LICENSE RIGHTS

This invention was made, in part, with Government support under USDA/ARS CRADA Grant #58-3K95-M-764, USDA/CSREES Grand #99-34211-7379, USDA/CSREES Grant #99-34382-8351, and USDA/ARS Specific Cooperative Agreement #58-3625-7-113. The Government has certain rights in this invention.

### OBJECT OF THE INVENTION

An apparatus and method for detecting ingesta or fecal contamination on a user's hands or other object using fluorescent spectroscopy is disclosed. Specifically, there is disclosed a system including a supporting structure which supports a diffuse light source. The light source emits light into an area adjacent to the system, where the light has a wavelength effective to elicit fluorescence from any ingesta or fecal matter on the object of interest at a wavelength between about 660 to 680 nm. There is also included a light detection device to detect light at a wavelength between about 660 to 680 nm from the area adjacent to the system. The detection of light at a wavelength between about 660 to 680 nm indicates the presence of fecal contamination or other ingesta. There is also disclosed a method of using such a device to detect the presence of such contamination, optionally including further steps to identify the source of any contamination and to modify any practices so that the spread of contamination may be reduced.

### FIELD OF THE INVENTION

The invention relates to an improved method and apparatus for detecting fecal or ingesta contamination on a user's hands or a surface, or objects such as food products, cooking or cutting utensils, using visible light fluorescent spectroscopy.

Microbial pathogens in food cause an estimated 6.5 million to 33 million cases of human illness and up to 9,000 deaths annually, according to the Council for Agricultural Science and Technology. Furthermore, the USDA Economic Research Service has recently reported that the annual cost of the food-borne illnesses caused by six common bacterial pathogens, Campylobacter spp., Clostridium perfringens, Escherichia coli 0157:H7, Listeria monocytogenes, Salmonella spp., and Staphylococcus aureus, ranges from 2.9 billion to 6.7 billion dollars (Food Institute Report, USDA, AER, December, 1996). The foods most likely to cause these illnesses are animal products such as red meat, poultry and eggs, seafood, and dairy products, along with human fecal to oral transmission.

Harmful bacteria are present in feces and can be spread by contact with contaminated sources. The handling of food containing such contamination often causes the spread of these harmful bacteria, typically by the contamination coming into contact with the hands or utensils used by food preparers. There is a need for a device to determine in real time if fecal contamination is present on the hands or objects used by those working in the food service industry.

In addition, fecal contamination can arise from other sources, as may be seen in the child care, geriatric care, or healthcare industries, or many other places. In these industries, this contamination can similarly be spread by workers. A device is needed in these and other contexts to assist workers in ensuring that contamination is not present, and where its presence is detected, ensuring that it is removed before it is spread.

Currently, there are a variety of methods available to determine whether fecal contamination is present on meat or other objects. These methods typically include human visual inspection, microbiological culture analysis, bioluminescent ATP-based assays, and antibody-based microbiological tests.

Fluorescence spectroscopy has been commonly used for the analysis of a variety of compounds, microorganisms, and tissues. The use of fluorescence spectroscopy for the detection of contaminants on foods has also been previously disclosed. For example, Alfano (U.S. Pat. No. 5,474,910) disclosed a method and apparatus for detecting biological molecules and microorganisms by irradiating the sample material with UV light at a wavelength between about 250 to 325 nm and measuring the resultant fluorescence. Alfano further disclosed that the process could be used for detecting the bacterial spoilage of food products, including meat and poultry. Unlike the disclosure in Alfano, which teaches a method that detects biological molecules and micoorganisms, the present invention instead teaches the detection of the presence of chlorophyl, or the host in which the bacteria lives, and does so by irradiating a sample material with light at a wavelength between about 380 nm and 470 nm rather than 250 to 325 run. More recently, Waldroup and Kirby (U.S. Pat. Nos. 5,621,215 and 5,895,521) disclosed a method and apparatus for detecting the contamination of meat or poultry with ingesta or fecal material. As described therein, the meat or poultry is illuminated with UV light having a wavelength between about 320 to 420 nm, and examined for fluorescence.

There is also disclosed in U.S. Pat. No. 5,914,247 a method and apparatus for detecting ingesta or fecal contamination on an animal carcass in near real-time using fluorescent spectroscopy. As taught therein, the surface of the carcass is illuminated with UV or visible light having a wavelength between 300-600 nm, preferably between about 400 to 440 nm or between about 510 to 600 nm, and most preferably between about 410-430 nm and/or between about 520-540 nm, and fluorescent light emissions having a wavelength between about 660 to 680 nm are then detected. The invention taught by Casey et al is useful for detection of ingesta and fecal contamination during the high speed processing of animal carcasses in a slaughterhouse, and is particularly adapted to be used within a short time after slaughter. However, the device described in the '247 patent is not compact, lightweight, portable, inexpensive, or suited to the spot-checking of the hands of workers, or the objects which may come into contact with fecal matter or ingesta, but is instead directed at examination of meat products at high speeds in a slaughterhouse setting.

Unfortunately, many of these procedures are either labor intensive, time consuming, and insensitive, require large amounts of floor space, or are not cost effective on a small scale, and thus are inappropriate for the food service, healthcare, child care or similar industries which may allow exposure to fecal contamination. Additionally, there are currently no known commercial, real-time systems available for detection and elimination of fecal material and the potentially harmful bacteria that can be present in this fecal material. As a result, contamination that may occur from shipping, handling or dissemination by retail or commercial outlets often goes undetected. Where contamination occurs beyond the packing plant, it is often missed and not discovered until sickness or death occurs. There is a need for an objective device which will give the average-sized retailer or commercial vendor the ability to ensure that its workers are not introducing or spreading contamination through their hands or their working utensils prior to the sale or serving of the food being handled.

Accordingly, there is a need for a low-cost device which can quickly, objectively, and accurately be used to detect whether protein sources, such as beef, lamb, pork, chicken, turkey and the like, contain fecal contamination at locations other than the slaughterhouse, such as at grocery stores and restaurants.

There is also a need for a device and method that the meat processing and grocery industry can rely upon to objectively certify that their product is free of contamination. Such a device and method may be incorporated into a routine quality control process or integrated into an employee identification scheme.

There is also a need for a device which can safely, quickly and accurately detect the presence of fecal matter on objects other than the protein source itself. For example, in the food services, healthcare, child care and other industries which allow for exposure to fecal contamination, there is a need for a device which can quickly, accurately and objectively detect whether fecal matter is present on a worker's hands or clothes, or objects such as knives, cutting boards and similar devices which may come into contact with fecal contamination.

There is also a need for a device that provides for a real-time method of determining whether contamination is present, such that the spread of such contamination may be reduced. Such a device would also allow workers to take steps to remove such contamination before it is spread to other people or objects, and further to adjust their practices to prevent such contamination in the future. In order to be useful to food preparation industry, or the childcare and healthcare industries, such a device would also have to be affordable and small enough to fit within a minimal amount of space. There is also a need for a device that may be made available to employees for use prior to their returning to work after using the restroom such that contamination may not be spread.

There is also a need for a device which serves the purposes listed above and which also allows for hands-free operation.

There is also a need for a device, which can objectively identify any fecal contamination on the hands of employees that can be integrated into an employee identification system. This system can also be used to screen workers prior to entering the workplace or beginning their shift. This system can be used as and integral part of an overall quality control or Hazardous Analysis Critical Control Point (HACCP) program or other system.

### SUMMARY OF THE INVENTION

We have now invented a novel and improved method and apparatus for detecting ingesta or fecal contamination on the surface of a user's hands or an object using visible light fluorescent spectroscopy. According to the present invention, there is disclosed a system which allows a hand or other object to be placed in a designated spatial area and illuminated with UV or visible light emitted by a light source. The UV or visible light has a wavelength effective to elicit fluorescence of feces or ingesta at a wavelength between about 660 to 680 nm. There is also included a detector to detect fluorescent light emissions having a wavelength between about 660 to 680 nm from the area adjacent to the system of the present invention. The emission of fluorescent light having wavelengths between about 660 to 680 nm is an indication of the presence of ingesta or fecal material on the hand or other object. A processor or CPU processes the signal from the detector and transmits it to a result indicator, or an LCD or display monitor, or an external network or employee ID reader, or any combination thereof. A proximity sensor may also be optionally used to ensure that an object is present in the area adjacent to the system of the present invention before the light source will be activated.

In accordance with this discovery, it is an object of this invention to provide an apparatus for real-time detection of ingesta or fecal contamination on the surface of worker's hands or the objects they use to handle and prepare food.

It is also an object of the present invention to provide a device which may be used to detect fecal matter on the hands of workers in various industries, as may arise from a variety of sources. Once such contamination is identified, steps may be taken to remove such contamination before it is spread. It is intended that such industries as meat processing, healthcare, child care, and food sellers and preparers could use such a device.

It is also an object of the present invention to provide an apparatus that may additionally be used to inspect meat products such as such as beef, lamb, pork, chicken, turkey and the like, and the tools used to process them, for fecal contamination.

It is also an object of the present invention to provide an apparatus and method to identify such contamination and then to take steps to modify the workers' activities or processes to prevent such contamination in the future.

Another object of the present invention is to provide safety features, which minimize the likelihood of a user being exposed to the light emitted.

It is an object of the present invention to provide a device and method that the food preparation industry can rely upon to certify that their food is free of contamination. Such a device and method may be incorporated into a routine quality control process, or as part of a HACCP or other food safety program.

Another object of the invention is to objectively identify any fecal contamination on the hands of employees and integrate such information into an employee identification system. This system can also be used to screen workers prior to entering the workplace, beginning their shift, or after using the restroom. This system can be used as and integral part of an overall quality control or HACCP system.

Another object of the present invention is to provide an integrated imaging system which can provide additional sensitivity over utilizing the human eye to detect the fluorescence of the fecal material. Yet another object of the present invention is to provide an apparatus which meets the above needs and is affordable and small enough to fit within a minimal amount of space.

Other objects and advantages of the invention will become apparent from the ensuing description.

### BRIEF DESCRIPTION OF THE DRAWINGS

The following figures set forth preferred embodiments the present invention:

FIG. 1 is a perspective view of a preferred embodiment of the present invention.

FIGS. 2 and 3 are perspective views of a preferred embodiment in use illuminating a user's hands.

FIG. 4 shows the configuration of the components within a preferred embodiment of the present invention, including: a light source or illumination system that illuminates an area adjacent to the system; a filter; a detection system; a processor such as a CPU; an LCD or monitor display; a result indicator; and an optional external network or employee identification reader.

FIGS. 5(a)-(d) show the illumination source and resulting emission spectrum created by the use of present invention to detect human stool resulting from a leafy green diet.

### DETAILED DESCRIPTION OF THE INVENTION

The process and apparatus of this invention may be used for detecting the ingesta or feces from any green-plant-eating animal or person that may be present on the surface of a worker's hands or clothes. It may also be used for detection of fecal matter on other objects, including on cuts of meat of wild or domestic meat producing animals, including but not limited to facultatively herbivorous or plant-eating mammals and birds such as bovine, poultry, porcine, ovine, caprine, equine, and ratites, especially cattle and calves, hogs, chickens, turkeys, sheep, and goats.

The apparatus may also be used on objects used for food handling, including knives, cleavers, cutting boards and the like. The apparatus may also be used to detect the presence of fecal contamination on the bodies or clothing of workers who may come into contact with fecal matter.

Detection of ingesta and feces in accordance with this invention is based upon applicants' discovery that the ingesta and feces of plant eating animals exhibit fluorescence at wavelengths between about 660 to 680 nm when illuminated with appropriate UV or visible excitation light, such as light having wavelengths between about 380-470 nm. This optical characteristic is ubiquitous in animals that are consuming plant material, particularly plant material containing photosynthetic pigments such as chlorophyll.

In its simplest form, the apparatus of the present invention includes an excitation source such as a lamp or laser for illuminating the surface of the object to be analyzed with UV or visible light having a wavelength effective to elicit fluorescence of feces at a wavelength between about 660 to 680 nm, and a device for detecting fluorescent light emissions having a wavelength between about 660 to 680 nm.

### EXAMPLE 1

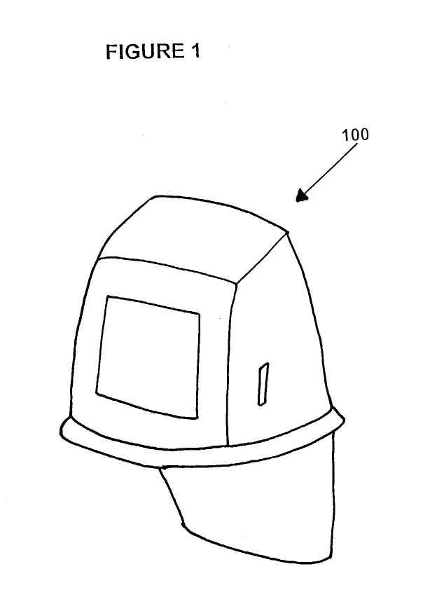

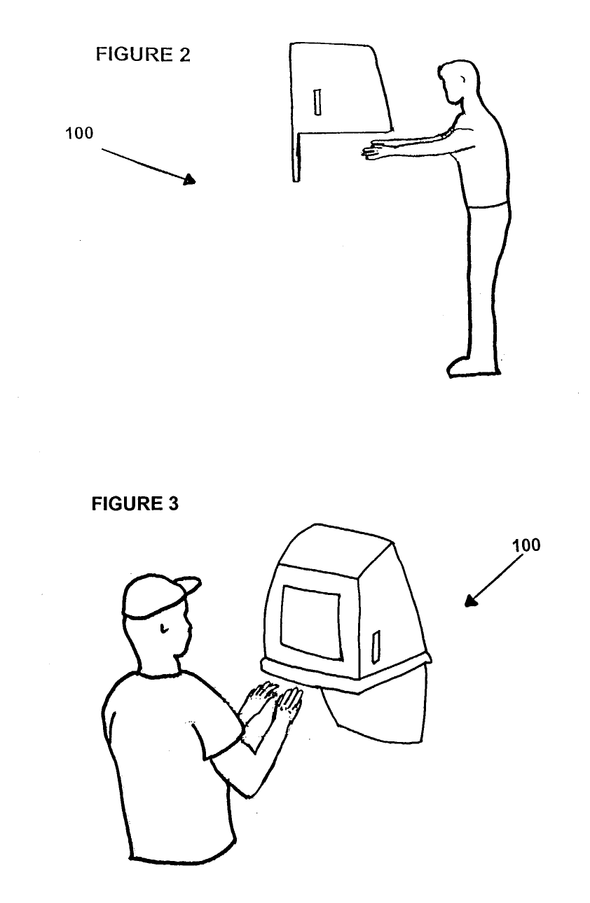

The preferred embodiment of the present invention 100 can be seen with reference to FIGS. 1-5. A perspective view of such an embodiment 100 is shown in FIG. 1. FIGS. 2-3 depict a typical user employing an embodiment of the present system 100 to inspect his hands, or any other object, for contamination. It is to be understood that the word “object” as used in this Specification is meant to include both meat products and non-meat items, such as clothing, utensils or even a person's hand.

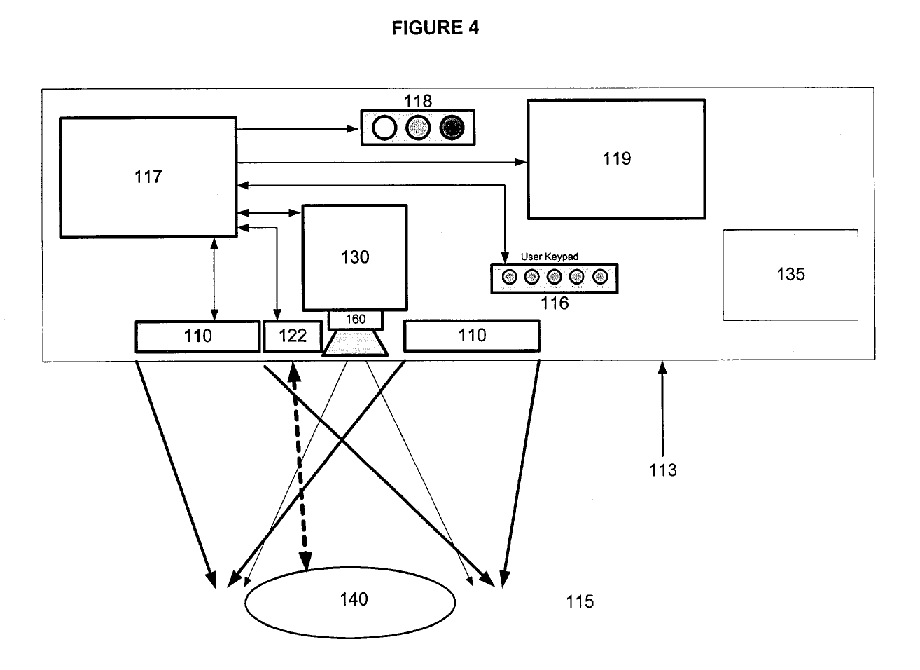

The configuration of such a preferred embodiment is shown in FIG. 4, and includes a mounting structure 113 supporting a diffuse light source 110 capable of generating light in the 380-470 nm (blue) range. Emission light from light source 110 can be created by an array of LED's, mercury vapor lights, fluorescent lamps any other source well-known to those in the art to be capable of generating light in the appropriate range. In a particularly preferred embodiment, the light is emitted from an array of light emitting diodes with a peak emission wavelength of 420 nm which are positioned so as to permit illumination of the object of interest when the object is placed in an area 115 adjacent to the system 100 of the present invention.

The system may be mounted on a wall or other supporting device leaving an adjacent area 115 at least large enough for an object 140 to be examined for contamination. The preferred embodiment also includes an detection device 130 such as a photodetector or CCD sensitive to at least 660-680 nm light. Without being limited thereto, suitable photodetectors for use herein include photodiode detectors, photomultipliers, amplifiers or image intensifiers, CCD cameras, and photocathodes and microchannel plates (i.e. “Night vision” technology). One or more optical filters 160 are preferably positioned between the adjacent area 115 and the photodetector to selectively transmit light in the range of about 660-680 nm light, while preventing transmission of back-scattered excitation light. Filters are preferably effective to remove wavelengths of light less than about 660 and greater than about 680 nm.

A processor 117, such as a CPU, controls the operation of the system, including receiving signals from an activation device 116, such as a user keypad. Processor 117 receives a signal from the detection device 130 and transmits it to a result indicator 118, or a display monitor 119, or an external network or employee ID reader, or any combination thereof. The entire system is powered by a power source 135, such as a battery or power cord connected to a utility.

A proximity sensor 122 may also be optionally used to ensure that an object is in fact present in the area 115 adjacent to the system 100 of the present invention before the light source will be activated. Specifically, such object sensing device 122 or proximity sensor may provide for electronic control of the light emissions, such that light will not be emitted from the light source unless an object to be examined is within the adjacent area 115, or alternatively, within a certain specified distance from the light source. Such use of a distance sensor and affiliated circuitry provides for increased safety to the user and others in the vicinity in that the device will not be activated except when there is an object 140 present in the area 115 adjacent to the system, thus providing the increased benefit of reducing any unintended and thus unnecessary exposure to the light source 110. Object sensing technologies appropriate for such an embodiment would be well-known to those in the distance-sensing art and would include, by way of example only, infrared and ultrasonic proximity-sensing or photo-electric technologies. The circuitry for creating such a safety mechanism is also well known in the art.

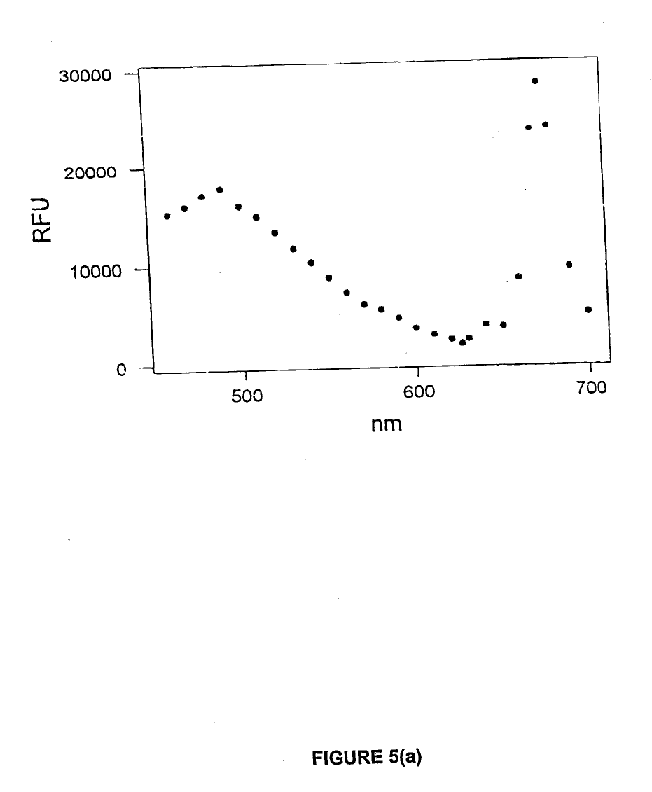

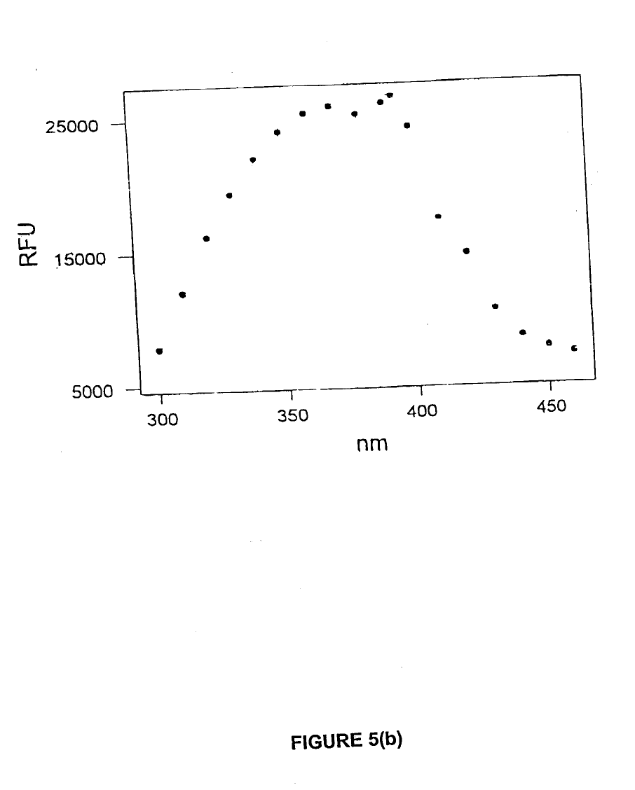

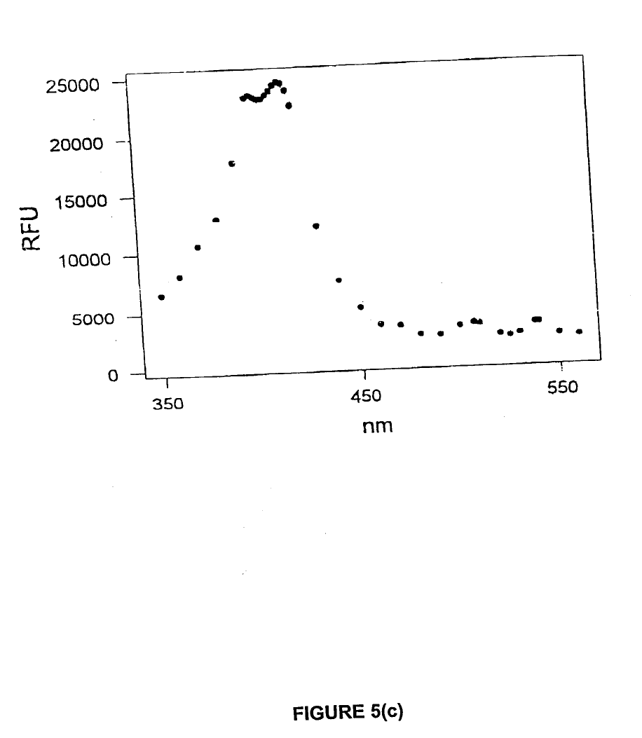

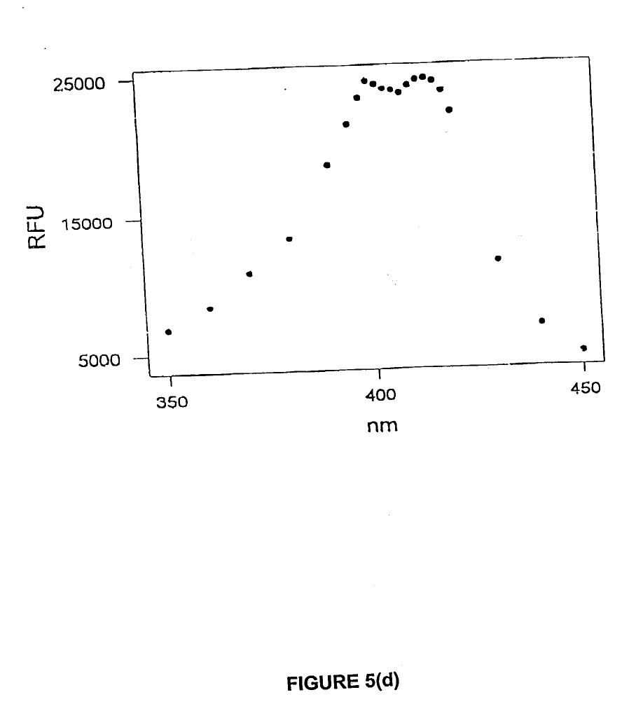

In an alternative embodiment, the output signal from the photodetector may be relayed to a recording instrument, such as an oscilloscope, desktop computer, hard drive, printer or any other device known in the art for presenting or storing a graphical display of fluorescent spectra intensity. For example, FIGS. 5(a)-(d) depict the illumination source and resulting emission spectra created by the use of present invention connected to a printer. Note that the spectra in FIGS. 5(a)-(d) depict the use of the present invention used to detect human stool resulting from a leafy green diet.

In another alternative embodiment, the photodetector may be in communication the processor, which is in turn in communication with a cleaning/disinfection indicator when the fluorescent intensity at the measured 660-680 nm range has exceeded a predetermined threshold value. Signals may include for example, audible alarms, visible lights or LEDs, or any combination of the above. Thus, as taught herein, the present invention may aid in objectively identifying the presence of contaminant.

The operation of the present invention can also be appreciated with respect to FIG. 4. In operation, the light source 110 is activated when the user puts an object 140, such as a hand or an instrument, into the adjacent area 115. If fecal matter is present, the matter will fluoresce at 660-680 nm (red). Thus, detection by detector 130 of fluorescent light emissions between about 660 to 680 nm indicates the presence of ingesta or fecal material.

Upon detection of ingesta or fecal contamination, the user's hand or other object may be washed, disinfected or otherwise treated to remove ingesta or feces from the surface thereof. The process for detecting ingesta and feces on the washed surface is then repeated, followed by additional washing and/or decontamination steps if necessary, until all traces of ingesta or feces have been removed or destroyed. A variety of wash solutions or disinfectants are known in the art and are suitable for use herein and include but are not limited to pressurized water or steam sprays, organic acids, chlorinated acids, inorganic acids, detergents and treatment with radiation. Once the user's hands or other object has been determined to be free of contamination as evidenced by the lack of fluorescence at the described range, the object may be returned to use or prepared for consumption.

The detection of ingesta or fecal contamination on the object also allows the user to adjust and improve their work practices in order to prevent contamination wherever possible and increase sanitation. When the present invention is used on meat, an additional benefit is an improvement in meat quality.

In yet another embodiment, the system can be connected to an employee identification system for monitoring cleanliness after hand washing or handling of potentially contaminated meat products. Such a system may additionally be operated in a “wireless” mode to update a central database on a given employee's cleanliness prior to entering the workplace. By way of example, the use of a photodetector and recording mechanism may be useful for the detection of fecal matter on the hands or clothing of workers at a restaurant, such as when they first report for work or at various times throughout the day. Such a system would be valuable to audit the cleanliness of workers and keep records of those tests.

Such a system may also be used as part of a method for reducing the spread of ingesta or fecal contamination by a worker from an object to other items in a workplace. Again, such objects would include the hands or clothing of workers in the food processing or food handling industries, or any worker who handles meat and non-meat objects which may potentially be contaminated. Such objects would also include the hands of such workers at the time they report for work, after bathroom break, or any time throughout the course of the day.

Such a method for reducing the spread of contamination would include first placing the object into an area adjacent to the present system. This step would occur at least one time per day, and ideally would occur periodically throughout the day, including when the worker first reports to work, after bathroom breaks, or at random or periodic intervals. Once the object is placed in the adjacent area, the object would be illuminated with light having a wavelength effective to elicit fluorescence at a wavelength between 660 to 680 nm. Once illuminated, a step of detecting fluorescent light emission from the surface of the object at a wavelength between about 660 to 680 run would follow, wherein detection of fluorescent light emission at said wavelength between about 660 to 680 nm is an indication of the presence of ingesta or fecal material on said surface.

To maximize the usefulness of this process, the results of the detecting step could be preserved for later review. By reviewing the preserved results, the user could identify trends relating to contamination, and thus take corrective action based upon these trends to reduce the instances of continued handling of contaminated objects. Such corrective actions could include anything from cleaning the contaminated object before returning to the work station, to implementing required cleaning steps at various stages or times.

It is understood that the foregoing detailed description is given merely by way of illustration and that modifications and variations may be made therein without departing from the spirit and scope of the invention.

What is claimed is: Apparatus claims

1. A system for detecting the presence of ingesta or fecal matter on the surface of an object that is placed in an area adjacent to the system, the system being mounted on a support device such as a wall, the system comprising:
a) a supporting structure;
b) a light source;
c) said supporting structure supporting said light source;
d) said light source emitting light into the area adjacent to the system;
e) said emitted light having a wavelength effective to elicit fluorescence from the ingesta or fecal matter on the object at a wavelength between about 660 to 680 nm;
f) a light detection device;
g) said light detection device being positioned so as to detect fluorescence light emissions from the area adjacent to the system;
h) said light detection device detecting fluorescent light emissions having a wavelength between about 660 to 680 nm from the object surface;
i) a light filter;
j) said light filter being positioned between said light detection device and the area adjacent to the system;
k) said filter substantially filtering out light other than light at a wavelength between about 660 to 680 nm;
l) a processor;
m) an indicator;
n) said processor being in communication with said light detection device; and
o) said processor transmitting a signal between said light detection device and said indicator.

2. The system of claim 1, wherein:
said light source emits light at a wavelength between about 380 to 470 nm.

3. The system of claim 2 where said light source includes a laser, an array of LEDs, a mercury vapor light source, or fluorescent lamps.

4. The system of claim 3, wherein said light detection device includes a photodetector or a CCD.

5. The system of claim 4 where said photodetector comprises photodiode detectors, photomultipliers, amplifiers, image intensifiers, CCD cameras, photocathodes, or microchannel plates.

6. The system of claim 1 wherein said filter substantially filters out light in the range between about 320 to 540 nm and above about 680 nm.

7. The system of claim I further comprising a viewing lens or display screen in communication with said processor.

8. The system of claim 1 further comprising a recording instrument in communication with said processor.

9. The system of claim 8 wherein said recording instrument includes an oscilloscope, a desktop computer, a hard drive, or a printer.

10. The system of claim 1 wherein said indicator is an audible alarm, visible lights, LEDs, or any combination thereof.

11. The system of claim 1 further comprising a means for detecting the presence of an object to be examined within the area adjacent to the system.

12. The system of claim 11, further comprising:
a) a means for preventing said light source from emitting light;
b) wherein said means for preventing prevents said light source from emitting light unless said means for detecting detects the presence of an object within the area adjacent to the system.

13. The system of claim 11, wherein said means for detecting includes infrared proximity sensing, ultrasound proximity testing, or photo-electric testing.

14. A system for detecting the presence of ingesta or fecal matter on the surface of an object that is placed in an area adjacent to the system, the system being mounted on a support device such as a wall, the system comprising:
a) a supporting structure;
b) a light source;
c) said supporting structure supporting said light source;
d) said light source comprising light emitting diodes in an array emitting light at a wavelength of about 420 nm into the area adjacent to the system;
e) a light detection device;
f) said light detection device being positioned so as to detect fluorescence light emissions from area adjacent to the system;
g) said light detection device detecting fluorescent light emissions having a wavelength between about 660 to 680 nm from the object surface.
h) a light filter;
i) said light filter being positioned between said light detection device and the area adjacent to the system;
j) said filter substantially filtering out light other than light at a wavelength between about 660 to 680 nm;
k) a processor;
l) an indicator;
m) said processor being in communication with said detection device; and
n) said processor transmitting a signal between said light detection device and said indicator.

15. A method for detecting the presence of ingesta or fecal matter on the surface of an object using a system, where the system is mounted on a support device such as a wall and has a supporting structure and a light source which emits light having a wavelength effective to elicit fluorescence from the ingesta or fecal matter on the object at a wavelength between about 660 to 680 nm, comprising the steps of:
a) placing the object in an area adjacent to the system;
b) illuminating the object in the area adjacent to the system with light having a wavelength effective to elicit fluorescence from the ingesta or fecal matter at a wavelength between 660 to 680 nm; and
c) detecting fluorescent light emission from the surface of the object at a wavelength between about 660 to 680 nm, wherein detection of fluorescent light emission at said wavelength between about 660 to 680 nm is an indication of the presence of ingesta or fecal material on said surface.

16. The method of claim 15 wherein the method further comprises washing or decontaminating the object when said detecting step results in any fluorescent light emission from said object at a wavelength between about 660 to 680 nm being detected.

17. The method of claim 16 wherein said washing or decontaminating step is performed using a wash solution including pressurized water, steam, organic acids, chlorinated acids, inorganic acids, and detergents, or any combination thereof.

18. The method of claim 16 further comprising repeating said illuminating and detecting and washing or decontaminating steps until no fluorescent light emission having a wavelength between about 660 to 680 nm is detected.

19. A method for reducing the spread of ingesta or fecal contamination by a worker from an object to other workers or other items in a workplace, comprising the steps of:
a) placing the object in an area adjacent to a system, where the system has a supporting structure and a light source which emits light to the area adjacent to the system having a wavelength effective to elicit fluorescence from the ingesta or fecal matter on the object at a wavelength between about 660 to 680 nm;
b) said placing step occurring at least one time per day;
c) illuminating the object within the chamber with light having a wavelength effective to elicit fluorescence from the ingesta or fecal matter at a wavelength between 660 to 680 nn; and
d) detecting fluorescent light emission from the surface of the object at a wavelength between about 660 to 680 nm, wherein detection of fluorescent light emission at said wavelength between about 660 to 680 nm is an indication of the presence of ingesta or fecal material on said surface;
e) preserving the results of the detecting step for later review;
f) reviewing the preserved results of the detecting step to identify trends relating to contamination; and
g) taking corrective action based upon the trends to reduce the instances of continued handling of contaminated objects.
